(19) United States
(12) Patent Application Publication
(10) Pub. No.: US 2011/0230250 A1
(43) Pub. Date: Sep. 22, 2011

(54) System and Method of Adapting Electronic Amusement Games To Electronic Gaming

(76) Inventor: Leonard M. DeAngelo, Palm Beach Gardens, FL (US)

(21) Appl. No.: 12/724,469

(22) Filed: Mar. 16, 2010

(51) Int. Cl. A63F 9/24; A63F 13/00

(52) U.S. Cl. 463/20; 463/25

(57) ABSTRACT

An interactive game system and method for providing payouts based on independent chance driven outcomes. The interactive game system may include a first interactive segment from which a player interacts to achieve at least one specified outcome, and a second segment instantiated at least partially based on the at least one specified outcome. The second segment includes at least one of a plurality of discrete, chance driven independent payouts independent of the at least one specified outcome.

A system and method are disclosed for combining the excitement of amusement games with chance driven outcomes of electronic gaming, and more specifically to a system and method of adapting electronic amusement games to electronic gaming.

### BACKGROUND

Amusement games include mechanical or electronic gaming machines that do not provide winnings or only provide winnings in the form of free games on the machines. An electronic amusement game is a game that employs electronics to create an interactive system within which a player can play. A common form of electronic amusement game is the video game. Other forms of electronic amusement games include handheld electronic games, standalone systems, such as pinball or slot machines, and audio games. These amusement games share the common attributes of continuous excitement, interactive feel, and entertainment value. Amusement games are often based on skill, such as hand-eye coordination, and therefore lack the statistical characteristics of games of chance found generally in the gaming industry.

Electronic gaming devices offered by the gaming industry may be restricted to the traditional reel slot and video slot style games, which offer discrete independent outcomes that mimic the physical restrictions of reels or number of cards in a poker hand. These discrete independent outcomes necessary to a gaming device do not lend themselves to interactive continuous skill level of play that is common to the art of electronic amusement devices. Electronic gaming devices generally do not enhance the player's entertainment value in the same way as the electronic amusement industry.

The skill factor of electronic amusement games creates fairness problems when applied as a gaming device and the continuous long fast action essential to the entertainment aspect of electronic amusement games may present problems to a gaming device that needs discrete outcomes definable within a cycle of possible outcomes in order to present fair payouts.

Prior attempts to deal with these distinctions have attempted to apply amusement style games to a gaming device by allowing the player to activate targets in a very restrictive repetitive style. These prior attempts generally are unsatisfactory because the attempts eliminate the skill of the player operating a controller, which is an entertaining aspect of the electronic amusement games, and the attempts do not provide the player the ability to progress from gaming outcome to gaming outcome extending play in a continuous entertaining manner common to electronic amusement games.

It is desirable to provide a gaming system and method that has the continuous excitement, interactive feel, and entertainment value of an electronic amusement device, retains the statistical characteristics of a traditional gaming device, and provides the gaming action and speed of traditional gaming devices with competitive earning potentials.

### SUMMARY

An interactive game system and method for providing payouts based on independent chance driven outcomes is disclosed. The interactive game system may include a first interactive segment with which a player interacts to achieve at least one specified outcome, and a second segment instantiated at least partially based on the at least one specified outcome. The second segment includes at least one of a plurality of discrete, chance driven independent payouts, each being independent of the at least one specified outcome.

The method of playing an interactive game system that provides payouts based on independent chance driven outcomes may include establishing a total bankroll for use in the interactive game system, defining a wager selected from the established total bankroll, the wager identifying the amount risked on a single play of the interactive game system, deducting the wager from the established total bankroll to permit play in the interactive game system, initiating interactive game play of a first interactive segment from which a player interacts to achieve at least one specified outcome of activating targets, disclosing a symbol based at least partially upon achieving at least one specified outcome during the first interactive segment, adding the disclosed symbol to a combination string of a second segment instantiated at least partially based on the at least one specified outcome, and determining if the combination string represents a winning combination independent of the at least one specified outcome.

Thus, the gaming method and system disclosed herein has the continuous excitement, interactive feel, and entertainment value of electronic amusement device, retains the statistical characteristics of a traditional gaming device, and provides the gaming action and speed of traditional gaming devices with competitive earning potentials. A player, using a controller, navigates through a game scene activating targets or achieving goals in the same manner as electronic amusement games. The player enjoys the experience of the amusement game, but the frequency of winning combinations and the long-term expected value payout percentages are based not on the player's skill but on random chance, which provides predictable and programmable payouts necessary for a gaming device regardless of player eye-hand coordination and skill level maneuvering the controller features.

### BRIEF DESCRIPTION OF THE FIGURES

FIG. 1 illustrates a block diagram of an interactive game system 100;

FIG. 2 illustrates a method 200 of play of interactive game system 100; and

FIG. 3 is a table of the payout probabilities of interactive game system 100.

### DETAILED DESCRIPTION OF THE DISCLOSED EMBODIMENTS

It is to be understood that the figures and descriptions herein are simplified to illustrate elements that are relevant for a clear understanding of the disclosure, while eliminating, for the purpose of clarity, many other elements found in amusement games and the gaming industry. Those of ordinary skill in the art may recognize that other elements and/or steps are desirable and/or required in implementing the disclosed embodiments. However, because such elements and steps are well known in the art, and because they do not facilitate a better understanding of the disclosure, a discussion of such elements and steps is not provided. The disclosure is directed to all such variations and modifications to such elements and methods known to those skilled in the art.

A system and method of electronic gaming that combines the excitement of electronic amusement game with the excitement of the chance to win a prize from a gaming device is described. The presentation of the game may include an electronic amusement device with the gaming outcome driven by chance. Gaming outcomes may be automatically played in a continuous mode utilizing variable length combination strings to add additional randomness to the play of the game.

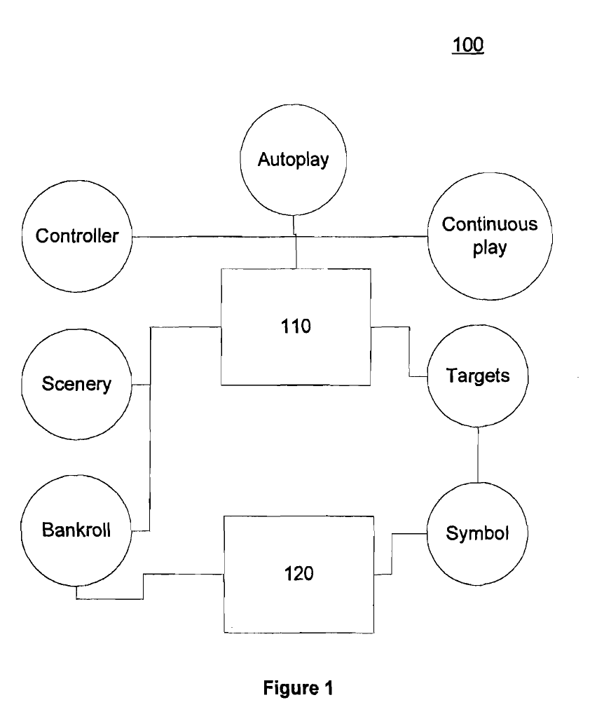

Referring now to FIG. 1, there is shown an interactive game system 100 according to the present invention. Interactive game system 100 may include an interactive segment 110 and a second segment 120. Interactive segment 110 may provide the framework with which a player interacts to achieve at least one specified outcome. Second segment 120 may include at least one of a plurality of discrete, chance driven independent payouts and may be instantiated at least partially based on the at least one specified outcome of interactive segment 110. The payout of second segment 120, and thereby the interactive game system 100 may be independent of the at least one specific outcome of interactive segment 110. Interactive game system 100 suggests earning a number of randomly awarded symbols via interactive segment 110, one at a time, to collect a group of symbols and arrive at an outcome based on the chances of collecting a winning group of symbols in second segment 120.

Interactive segment 110 may provide a player the ability to play an interactive portion of the interactive game system 100. Interactive segment 110 may utilize a player navigating through a scene activating targets to achieve goals using a controller, for example. Interactive segment 110 may include a central processor, a display, and sound capabilities to enhance play of interactive segment 110, and a controller for interacting with interactive segment 110. For example, the controller may control direction and speed as well as other characteristics of interactive segment 110, such as navigating an action figure through a game scene. The controller may allow selecting or activating targets, such as by using a button on the controller, for example. Examples of the controller include joysticks, handheld controller pads with multiple buttons and many film operated joystick like devices, steering wheels and pedals, guns, pinball flippers, and the like. The controller may also include a button for activating a target by shooting, punching, hitting it with a thrown or held object, or the like, or achieving a goal by maneuvering over, passing through, collecting, and the like, all of which are illustrative examples common to the art of the electronic amusement game industry.

Interactive segment 110 may include features to allow a player to choose what scenery or game type is desired to be played, or at what speed or level of difficulty, and the like.

An action figure may be an object that is navigated by the player through the interactive segment 110. The action figure may be any character, transportation vehicle, or object that is used by the player to activate targets and reach goals within interactive segment 110. Examples of action figures include characters that run, fly, jump and fight, transportation vehicles like cars, planes, rockets, fighter jets, boats and motorcycles, and objects like blocks or balls or any other maneuverable graphical or physical object.

The scene of interactive segment 110 may include any background. The scene may be or include computer graphics, video, physical maze, and the like. The scene generally sets the theme of interactive segment 110, such as a fighting game, racing game, maze type adventure game, or combinations or variations commonly known in the electronic amusement device industry. The scene may provide the framework of interactive segment 110 so that a target or goal may be sought and achieved.

A target may be an object within a scene that may be activated by the action figure according to interactive segment 110. Objects may be punched, bumped, shot, exploded, selected, run over or into, collected, found, and the like. A symbol may be displayed when the player activates a target. Targets may also display nongame symbols that may be relevant to interactive segment 110 as discussed herein below. Interactive segment 110 may work with any style electronic amusement game, including but not limited to, freestanding devices, progressives, multilink progressives, gaming tournaments, networked lottery terminals, remote Internet gaming, personal computing or any other gaming application.

The goal of the interactive segment 110 may be to achieve a desired outcome, such as by activating targets using the action figure. The reward for achieving a goal of interactive segment 110 may include earning a symbol that may be passed to or used within second segment 120. Symbols generally may relate to the theme of interactive game system 100 and may include stars, coins, balloons, flags, fruit, playing cards, characters, aliens, wildcards, bonus objects, and the like.

The symbol earned through playing interactive segment 110 may be one token in the game play of second segment 120. The player of interactive segment 110 may continue within interactive segment 110 achieving targets, and thereby earning symbols associated with second segment 120, until earning enough symbols to provide a symbol set required for one play of second segment 120. The player, thereby, may participate in the play of second segment 120 by earning symbols found in interactive segment 110, one at a time, until a full symbol set is achieved. A full symbol set may be defined as a combination string. The gaming device aspect of interactive game system 100 may result from the randomly generated symbols that comprise the combination string of second segment 120. More specifically, when the target of interactive segment 110 is activated a symbol for second segment 120 may be selected by the gaming program using a selector, such as a random number generator, that may be approved by the gaming industry. This random selection eliminates the skill factor for the gaming device since the speed of the game through the scenery and/or number of target activations within interactive segment 110 have no bearing on the selection of the symbol displayed. The symbols in second segment 120 may generally be provided by and create statistical probabilities independent of the target or goal of interactive segment 110. The probability of occurrence of a given symbol may be connected to the order in which targets are activated, to thereby eliminate the skill factor and provide the game with expected payout probabilities regardless of player skill or location with interactive segment 110.

The symbol of second segment 120 may be selected from an approved percentage sheet, which details the expected frequency of each symbol and the payout amount associated with each series of possible combinations as determined in second segment 120. This may be done using a combination string, which is a collection of randomly generated symbols in the play of second segment 120. The pattern of symbols collected may be used to determine the payout to the player as described in the payout schedule of second segment 120.

This combination string may be fixed in length, such as having three, four or five symbols. For example, a combination string may be three characters, such as stemming from a standard reel slot machine. While fixed in length, the combination string may be unlimited in overall length, by having a length of ten symbols, twenty symbols, or one hundred symbols, and may have no physical limitations. In essence, a combination string may take the form of a string of symbols from one to any number in length. The longer the length of the combination string, the longer the play time of interactive segment 110, as achieving more symbols requires activating more targets during interactive segment 110, and further may result in increased difficulty in matching a payout combination. Increasing the length of the combination string affects the statistics of matching a winning combination and therefore may allow for higher payout awards or jackpots for interactive game system 100.

The combination string of second segment 120 may be variable in length. For example, in sequential plays of second segment 120, the combination string may be a single symbol during the first play of second segment 120, five symbols long in the second play of second segment 120, and any random number long for a third or subsequent play second segment 120. The variable aspect of the combination string of second segment 120 may be governed by a series of rules. The rules may take the form of, for example, the combination string may never be greater than seven symbols, and two consecutive plays of second segment 120 may never have the combination strings from the two plays add to less than ten. These rules may govern the combination string in many different ways as would be apparent to those skilled in the pertinent arts.

Interactive game system 100, and more specifically interactive segment 110, may be operated in a continuous play mode. A continuous play mode may be a mode of play that may be selected by the player wherein interactive game system 100 automatically deducts a preselected wager amount and restarts second segment 120 once a previous session of second segment 120 ends allowing continuous play of interactive segment 110. The session bankroll may be automatically adjusted for the preselected wager amount at the beginning of each second segment 120 initiation. This continuous play mode allows interactive segment 110 to imitate electronic amusement devices with the uninterrupted action common to those games while still supporting discrete gaming outcomes necessary for a game of chance.

Interactive game system 100 may also include a winnings reinvestment feature. Such a feature may be configurable as a selectable feature that at the beginning of interactive game system 100 allows a player to have the winning payouts, to the extent winning occurs, added back to the session bankroll to extend the length of play of interactive segment 110. In a configuration where the player does not activate this feature, any winnings may be deposited in the player's total bankroll, not available in the session bankroll but be available to wager on the next session at the player's option.

The total bankroll is a total amount of money or credit a player is willing to risk in interactive game system 100. Credits are simply the cash equivalent of the value of one game and may be purchased, or earned through promotion, won as part of the play of interactive game system 100, or free for promotional purposes. The total bankroll may include a session bankroll amount when a session bankroll is established for the continuous play mode. When the player cashes out at the end of play, the total bankroll may be paid including any remaining credits or money in the session bankroll.

The session bankroll is the bankroll for a session of interactive game system 100 and may be different from the player's total bankroll available. The session bankroll may be the amount available to be automatically wagered during a series of automatic interactive games 100 and determines the minimum number of games during a given session when playing interactive game system 100 in the continuous play mode, for example.

A wager is the amount of money the player is willing to risk on a single play of interactive game system 100. The wager is the value of a credit and is the amount used to calculate any payout when a player has a winning combination as determined by second segment 120. The wager is the amount automatically deducted at the start of each game of interactive game system 100 from a player's total bankroll, or session bankroll when in continuous play mode, for example.

The flow of a game of interactive game system 100 may begin with a player establishing a total bankroll. Such a bankroll may be established using a network source or local source. Once the bankroll is established, a player may select the desired game options comprising the game scenery, skill level, continuous play mode, autoplay mode (described below), winnings to automatically reinvest into the session, or any other feature offered in playing a game on interactive game system 100. The player may establish a wager amount per game, such as one credit, for example, and the amount of the player's session bankroll, if playing in the continuous play mode. Play may then begin.

The wager amount is deducted from the total or session bankroll, as determined by play mode, and a player begins play by for example, moving an action figure through the scenery using the controller to search for targets or to reach goals. When targets are identified and found, the player may use controller to activate the disclosed target. Targets may be activated in any order, at any time, at the choice of the player, or according to the normal play of interactive segment 110. When a target or goal is activated, a randomly selected symbol from second segment 120 may be revealed and earned by the player. Symbols collected may be displayed in the sequence described on the display of interactive game system 100.

The player may continue activating targets in interactive segment 110 and earning symbol(s) for second segment 120, while those earned symbol(s) may be compared to the length of and possible symbol combination strings and payout amounts associated with second segment 120. Second segment 120 continues until a fixed number of randomly generated symbols are collected or a predetermined randomly selected variable length of symbols is collected. Once the second segment symbol length is generated, a single play of interactive game system 100 is complete.

If the player selected the continuous play mode, interactive game system 100 may seamlessly continue along the same scenery while adjusting the session bankroll for the wager allowing the player to continue playing interactive segment 110. Play may continue in an uninterrupted manner stringing one play of interactive game system 100 after another, while the session bankroll permits.

If the player selects the winnings reinvestment option in the continuous play mode, any payouts from a play of interactive game system 100 may be added to the session bankroll, thereby adding to the number of possible games of interactive game system 110 in a non-interrupted session. When the total bankroll or session bankroll is depleted, the player may import a new bankroll as desired. Alternatively, the session ends.

Interactive game system 100 may ensure that the statistical probabilities of second segment 120 are independent by applying independent probability distributions of possible symbols to targets activated in interactive segment 110 independent of the player's skill, and of the manner and order in which targets are activated during play of interactive segment 110. Even though player skill may enhance the entertainment value of the play of interactive game system 100, skill is eliminated from the gaming outcome.

Interactive game system 100 may also provide competitive decision frequency per minute with other gaming devices. The lengths of the combination strings of second segment 120, in conjunction with target frequencies of appearance in interactive segment 110, may be coordinated to provide gaming decisions per minute competitive with other gaming devices. Decision frequency per minute and gaming decision per minute are terms used to quantify the number of game outcomes per minute. Generally, the number of outcomes may vary from one to ten per minute for gaming devices and according to the disclosure herein interactive game system 100 may achieve similar decisions per minute.

As an example, if the action figure is a fighter jet and the targets are enemy planes, the player may use skill to maneuver the jet through the sky using the controller to search for enemy planes. As enemy planes are located, the player may activate each target by shooting an enemy plane and achieving a mortal hit. Interactive segment 110 may call second segment 120, which would then randomly select a symbol from the probability distribution of possible symbols, such as a “gold star” that would then be placed in position one on the display of second segment 120. The symbol selection process is totally independent of the play of interactive segment 110. The next enemy plane activated may cause a second randomly selected symbol to be placed in position two and the next a third randomly selected symbol into position three. Enemy planes may be activated in any order at the player's choice without affecting the outcome of second segment 120, since the symbols collected would be placed always in the one, two, three sequence. If the game is a three symbol game, then whenever the player mortally hits three enemy planes, the game of chance would be over, and second segment 120 is checked to determine if the symbols collected represented a winning outcome.

Interactive game system 100 may include other features, such as an autoplay feature that allows a player to enjoy a game of chance even if the player does not have the skill necessary to collect the necessary number of symbols, or a continuous play feature that credits winnings to and debits wagers from a player's account and allows the game to continue without interruption from one skill session to the next.

Interactive game system 100 also may include special targets such as bonus game targets, for example. A bonus game target may be a target that could be found within the scene during the normal play of interactive segment 110. The bonus game targets may display a price allowing the player to activate these bonus games. The bonus game, with similar characteristics as the individual game, may offer different scenery and sound with different jackpot payout schedules to add excitement and variety to interactive game system 100.

Interactive game system 100 may additionally include a series of special symbols. Special symbols may include wild symbols, bonus game symbols, jackpot bonus game symbols, and non-gaming symbols. A wild symbol may be a symbol that is used to substitute as any symbol in the combination string to extend a variable combination string of second segment 120. Wild symbols may be used as a substitute to any symbol and may act as another symbol in the probability distribution to calculate the payout percentage. If used to extend a variable string second segment 120, the wild symbol may have a payout value that in effect would statistically act as an additional wager that would have to be treated as a jackpot game for payout percentage calculation purposes.

A bonus game symbol is a symbol that when collected may have various levels of instant awards. The bonus game, or free game, may be played at any time or may be saved for later play. While in the continuous play mode, bonus games may be accumulated and may be activated at any time by the player, for example.

A jackpot bonus game is a symbol that when activated may automatically use all accumulated bonus game symbols in the jackpot bonus game of chance. A jackpot bonus game may have various levels of awards depending on the statistical probabilities assigned to the accumulation of multiple bonus game symbols. That is, the more symbols accumulated, the harder it may be to earn the next symbol. The underlying value of the symbol may be defined in the credits to be used in the calculation of the games expected payout percentage.

Non-gaming symbols may include symbols that are not included in the combination string. Such symbols have no impact on second segment 120. Non-gaming symbols may be used in the normal play of interactive segment 110.

Interactive game system 100 may also include features such as the ability to pause, stop, and continue, selection of skill level, and autoplay of interactive segment 110. Pause, stop, and continue may allow the player to stop the play of interactive segment 110 at any time during the action and restart when ready to resume. This feature may also allow the player to stop the continuous play of the next game of second segment 120, at any time after a gaming outcome is determined. A time delay countdown may be used to ensure that a reasonable timed pause is used.

A continue feature allows a player to restart the next game of chance at the same scenery location as the end of the last game or session. The player may select this feature and a wager amount. This feature may also include a time delay countdown that may run off and force interactive segment 110 to return to the beginning of the scene.

A skill level feature selectable by the player at the beginning of play of interactive segment 110 may allow for various levels of difficulty available to the player, such as associated with speed of play, controller difficulty, or other strategy. The skill level may also be associated with higher jackpot payouts and more favorable payout odds to the player, for example.

An autoplay feature may be selectable by the player at the beginning of play to provide controller functions to interactive game system 100 to allow automatic play of interactive segment 110 in activating targets and achieving goals and to provide symbols to second segment 120. In autoplay mode, the action figure may be automatically controlled to automatically activate targets and collect symbols for second segment 120, without requiring action by the player. An autoplay feature may provide a player a demonstration of how to maneuver through unfamiliar scenery, or the play of the game is affected by selection of higher skill levels, allowing players unskilled and unfamiliar with amusement games the opportunity to play the game, or for those physically unable to play the game by maneuvering the controller. The autoplay mode may be initiated automatically if the player is unable to collect symbols by activating targets while playing interactive segment 110 manually within a given period of time, such as 30 seconds, 60 seconds, or two minutes, for example.

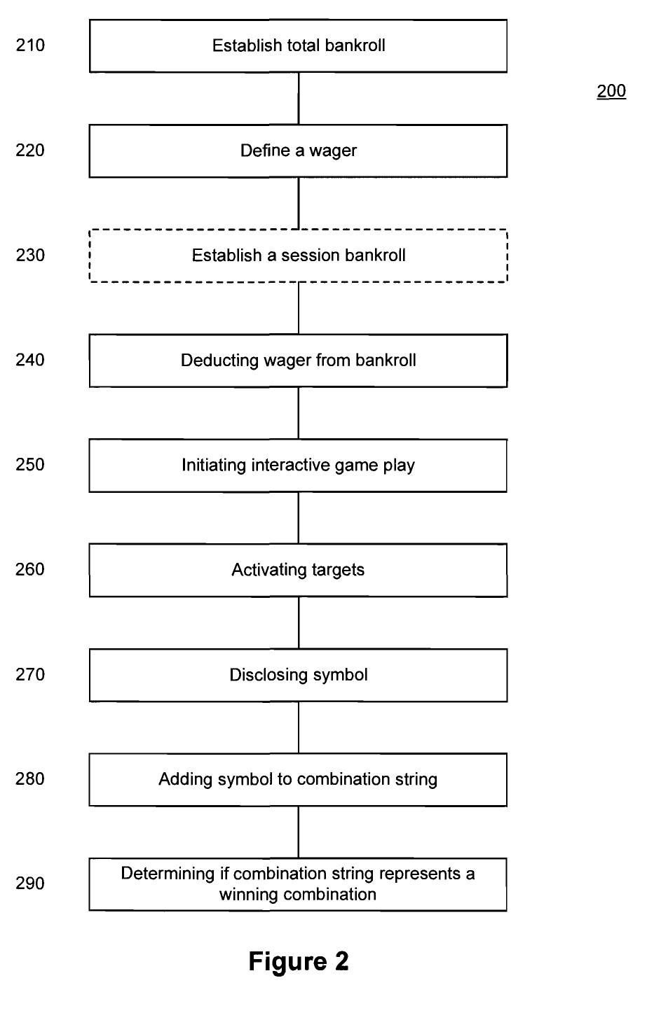

Referring now to FIG. 2, there is shown a method of play 200 of interactive game system 100. Method 200 may include establishing a total bankroll 210, defining a wager 220, optionally establishing a session bankroll 230, deducting a wager from session bankroll 240, initiating interactive game play 250, activating targets 260, earning symbol 270, adding symbols to combination string 280, and determining if a combination string represents a winning combination 290.

Establishing a total bankroll 210 may include entering money or transferring information regarding money or credits that a player is willing to risk in playing interactive game system 100. Establishing the total bankroll 210 may include inserting cash through a bill acceptor, electronically depositing funds through a network connection, scanning a credit/debit card, and/or providing a coupon identifying credits. Establishing a total bankroll 210 may include all money and/or credits earned or deposited by a player and may represent the amount available for cash out at any given time.

Defining a wager 220 may include defining an amount for wager on a game of interactive game system 100. A wager may be defined 220 and allocated from the established total bankroll 210. The wager may represent the amount that a player is willing to risk in a single game on interactive game system 100. The defined wager 220 may be deducted from the established total bankroll 210.

Optionally establishing a session bankroll 230 may include identifying a portion of the established total bankroll 210, such as a small portion, half, three-quarters or all of the established bankroll 210, for example. The session bankroll is the amount that a player is willing to risk in successive games on the interactive game system 100 as defined by the wager and game play. Established session bankroll 230 may allow interactive game system 100 to operate in a continuous play mode to enhance the play of interactive segment 110.

Deducting wager from session bankroll and/or total bankroll 240 may include initiating play of interactive game system 100 and determining payout percentages based on the deducted wager 240. In continuous mode, deducted wager 240 may be deducted from the session bankroll to monitor the session of play. The wager may be deducted from the total bankroll 240 whether in continuous mode or single play mode.

Initiating interactive game play 250 may include initiating interactive game system 100 by selecting skill level, scenery, and the like for interactive segment 110 and clearing the combination string of second segment 120. A player may participate in interactive game system 100 upon initiation and attempt to activate targets to thereby gain symbols, as discussed hereinabove.

Activating targets 260 may include using a controller to maneuver a figure within interactive segment 110 to achieve goals. As targets are activated 260, symbols may be earned.

Earning symbol 270 may be done by activating targets in interactive segment 110 to reveal the underlying symbol for use within second segment 120. The symbol disclosed may be selected by interactive game system 100 as defined by payout tables and probability functions, as set forth in greater detail herein throughout.

Adding symbols to combination string 280 may include adding an earned symbol 270 earned by activating a target 260 to a combination string and determining if the maximum length of the combination string is achieved. If the length is not met, interactive game system 100 continues, requiring a player to continue to activate targets and earn symbols, as discussed. If the length of combination string is met, a determination of payout may be performed.

Determining if a combination string represents a winning combination 290 may include a comparison of earned symbols comprising the combination string to the payout table. This comparison may result in a determination of the defined payout based on the randomly selected symbol string.

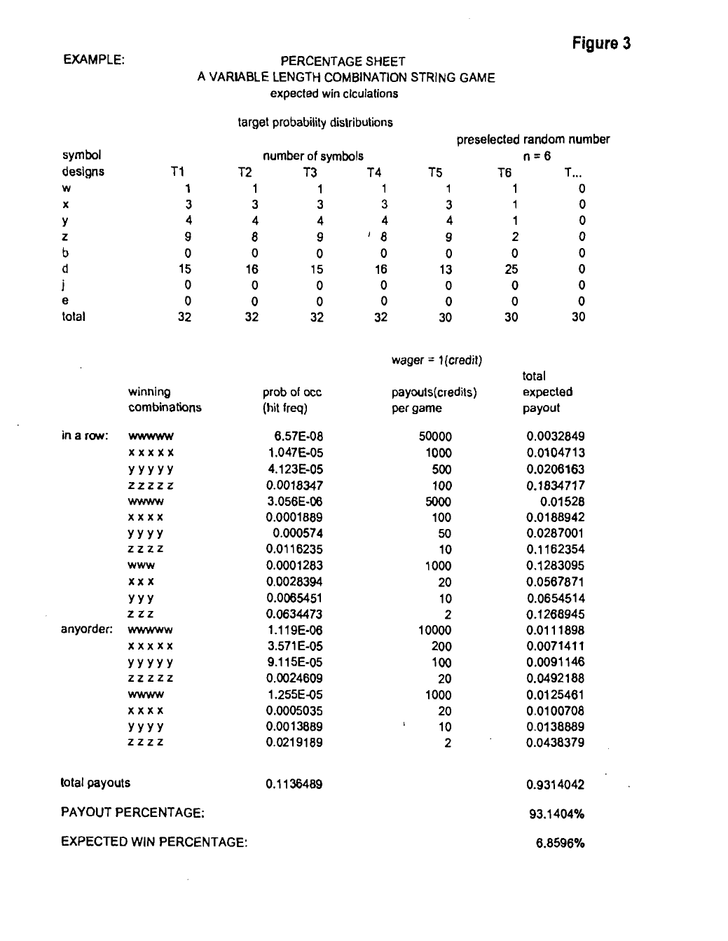

Referring now to FIG. 3, there is shown a table of the payout probabilities of interactive game system 100. Interactive game system 100 may use a predefined number of symbols achieved in second segment 120 by activating targets 110. Each symbol collected may be statistically independent from any other symbol. Symbols are sequentially identified for statistical probability calculation purposes. Each target activated has its own unique probability distribution of possible symbol outcomes. For example, the first gaming target activated uses the same probability distribution of possible symbols for selection of the symbol to display for each second segment 120 and, therefore, each target activated from T1 . . . Tn may be added to the probability distribution of possible outcomes. It is possible that second segment 120 calculates the payout percentages for targets T1 . . . Tn to be activated in a random order.

As shown in FIG. 3, interactive game system 100 may have a defined cycle that represents the total number of games that need to be played in order to play every possible combination string statistically possible. Using a variable combination string may require an additional random number to be preselected at the beginning of each game from an allowable integer range, such as minimum number of targets to maximum number of targets in the combination string. This number may allow for calculations of the payout percentages. For simplicity purposes and fair play in understanding of the gaming pay out, each game is likely to have a payout schedule displayed to the public. The microprocessor may be programmed with a series of probability distributions for randomly generated symbols. In essence, a unique percentage sheet may be provided for each value of an allowable outcome by interactive game system 100. These unique distributions may then have their own total payout and expected win calculations for each value and may be weighted together based on the probability of occurrence of each value of n to determine the overall expected win and payout percentages of interactive game system 100. As would be evident to those skilled in the pertinent art, the higher the allowable maximum number of targets, the longer each game of chance may take to complete. For example, a low value may be weighted higher than a high value, making shorter combination strings more common than longer combination strings, if desired.

As shown in FIG. 3, there is a summary of typical calculation of expected win and payout percentages for a single value of n. If second segment 120 requires that n be the same for each game, then the payout percentage of 93.1404% would be the payout percentage of the game for a constant combination string length equal to six, for example. If second segment 120 allows for multiple values of n, then the payout percentage of each value weighted for the probability of occurrence may be the game's overall payout percentage, represented as 92.3847% in the example, as shown in Table 1 below.

TABLE 1

| | Probability of | Payout % | Payout % |
|---|---|---|---|
| Value of n | occurrence | total | weighted |
| 5 | 40 | 90.637 | 36.2548 |
| 6 | 35 | 93.140 | 32.5991 |
| 7 | 25 | 94.123 | 23.5308 |
| Total | 100 | 92.3847 | |

The payout percentages for the values of n equal to five and seven above are assumed values for these calculations. Each value of n represented would have a percentage sheet as represented in FIG. 3.

The symbols w, x, y and z in FIG. 3 may be used for winning payout combinations. The symbol d may represent any symbol relevant to the play of interactive game system 100 and may have no value relative to the payout calculations. The other symbols b, t and e may be used for bonus and jackpot game symbols with assigned payout values. Additional symbols may be added, such as a random game ending symbol passed back to interactive segment 110 after the symbol has been collected. Any number of other symbols may be added to the possible outcomes. The total number of possible symbols per target used in this example is 32 and 30 for each of the different target distributions. Any number from one to x may be used for any of the targets based on the game designed and the winning combinations and payout amounts desired.

Although the disclosed embodiments have been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the claims as set forth hereinafter.

What is claimed is:

1. An interactive game system that provides payouts based on independent chance driven outcomes, said system comprising:
a first interactive segment from which a player interacts to achieve at least one specified outcome; and
a second segment instantiated at least partially based on the at least one specified outcome, wherein said second segment comprises at least one of a plurality of discrete, chance driven independent payouts independent of the at least one specified outcome.

2. The system of claim 1, wherein said first interactive segment comprises a video game.

3. The system of claim 1, wherein said first interactive segment comprises a scene.

4. The system of claim 1, wherein player interaction with said first interactive segment is enabled by a controller.

5. The system of claim 1, wherein achieving at least one specified outcome comprises activating targets within said first interactive segment.

6. The system of claim 1, wherein achieving at least one specified outcome comprises achieving goals within said first interactive segment.

7. The system of claim 1, wherein said second segment comprises a game of chance.

8. The system of claim 7, wherein the game of chance comprises collection of three symbols.

9. The system of claim 7, wherein the game of chance comprises four symbols.

10. The system of claim 7, wherein the game of chance comprises five symbols.

11. The system of claim 7, wherein the symbols are randomly generated.

12. The system of claim 1, wherein said first interactive segment enables a single payout of said second segment.

13. The system of claim 1, wherein said first interactive segment comprises a continuous play mode.

14. The system of claim 13, wherein said continuous play mode comprises at least two payouts of said second segment.

15. The system of claim 13, wherein said continuous play mode is driven by an established session bankroll.

16. A method of playing an interactive game system that provides payouts based on independent chance driven outcomes, said method comprising:
establishing a total bankroll for use in the interactive game system;
defining a wager selected from said established total bankroll, said wager identifying the amount risked on a single play of the interactive game system;
deducting the wager from said established total bankroll to permit play in the interactive game system;
initiating interactive game play of a first interactive segment from which a player interacts to achieve at least one specified outcome of activating targets;
awarding a symbol based at least partially upon achieving at least one specified outcome during the first interactive segment;
adding an awarded symbol to a combination string of a second segment instantiated at least partially based on the at least one specified outcome; and
determining if said combination string represents a winning combination independent of the at least one specified outcome.

17. The method of claim 16, wherein awarded symbols are randomly generated.

18. The method of claim 16, further comprising establishing a session bankroll for use in a continuous play mode.

19. The method of claim 16, wherein said combination string is variable in length.

20. The method of claim 16, wherein said combination string is fixed in length.

21. The method of claim 16, wherein said establishing a total bankroll comprises converting validated currency into credits on the interactive game system.

22. The method of claim 16, where said step of determining a winning combination is based on a payout schedule.

23. A chance driven independent payout interactive game device, said device comprising:
an interactive game portion providing a scene for playing an interactive game for activating targets and earning symbols; and
a payout means for paying a chance driven independent payout based on a collected series of symbols in said interactive game portion.

24. The method of claim 23, wherein earned symbols are randomly generated.
